(19) United States
(12) Patent Application Publication
(10) Pub. No.: US 2006/0123966 A1
(43) Pub. Date: Jun. 15, 2006

(54) Guide device for cutting work

(76) Inventor: Wan-Young Oh, Seoul (KR)

Correspondence Address: JONES DAY, 222 EAST 41ST ST, NEW YORK, NY, 10017, US

(21) Appl. No.: 11/041,100

(22) Filed: Jan. 20, 2005

(30) Foreign Application Priority Data
Dec. 14, 2004 (KR) 20-2004-0035431

(51) Int. Cl. B26D 7/01; B26D 5/08

(52) U.S. Cl. 83/565; 83/821; 30/286

(57) ABSTRACT

A guide device for cutting work, which is placed on a sheet material to guide a cutting blade that cuts the sheet material, is disclosed. The guide device includes a guide plate having a guide slot corresponding to a cutting line; and a sliding support combined in the guide slot to be sliding along the guide slot. At this time, a slit for inserting the cutting blade is formed in the sliding support in the same direction as the guide slot so that the cutting blade is inserted and supported in the slit.

### BACKGROUND OF THE INVENTION

1. Field of the Invention

The present invention relates to a guide device for cutting work, and more particularly to a guide device for cutting work, which is capable of cutting a sheet material such as paper and cloth into various shapes with the use of a cutting blade.

2. Description of the Related Art

Sheet materials such as various films, cloths, cards, letter papers and papers sometimes need to be cut into circular or other various shapes. In this case, a ruler or a guide plate having a shape for cutting is placed on the sheet material and then a cutter is used for cutting the sheet material. At this time, a cutting blade for cutting the sheet material is guided along the outline of the ruler or the guide plate. Thus, a user should carefully handle the cutting blade not to deviate from the outline of the ruler or the guide plate in order to cut the sheet material into a desired shape accurately.

However, in case of cutting a sheet material into a complex shape such as a circular or petaline shape, an advancing direction of the cutting blade is changed several times. Thus, during the cutting procedure, the cutting blade is apt to be departed from the outline of the guide plate, thereby making an error in cutting the sheet material.

In order to solve this problem, a guide device, which has a guide slot formed in a guide plate for a cutting blade to pass through and then allows a user to cut a sheet material along the guide slot, has been proposed.

This guide device however has a drawback that the guide slot is cut away little by little as the cutting process is repeated since the keen cutting blade is directly contacted with the guide plate. This makes the guide slot enlarged or widened, so the cutting accuracy becomes deteriorated.

Furthermore, in case that a cutting line is complex like a petaline shape, the guide device has a limitation in smoothly, accurately guiding the keen cutting blade only with the guide slot.

### SUMMARY OF THE INVENTION

The present invention is designed to solve the problems of the prior art, and therefore it is an object of the present invention to provide a guide device for cutting work, which is capable of guiding smooth sliding of a cutting blade so as to allow a user to easily cut a sheet material into circular and other various shapes like a petaline shape.

In order to accomplish the above object, the present invention provides a guide device for cutting work, which is placed on a sheet material to guide a cutting blade that cuts the sheet material, wherein the guide device includes a guide plate having a guide slot corresponding to a cutting line; and a sliding support combined in the guide slot to be sliding along the guide slot, wherein a slit for inserting the cutting blade is formed in the sliding support in the same direction as the guide slot so that the cutting blade is inserted and supported in the slit.

Preferably, the sliding support includes a combination member inserted into the guide slot so that the combination member has a hooking portion with a greater size than a gap of the guide slot, and the combination member is formed on an extension line of the slit for inserting the cutting blade.

More preferably, the combination member is composed of a pair of members opposite to each other with the slit being interposed therebetween.

In another embodiment, the guide slot may have at least one critical point, and the sliding support may include only single combination member.

Preferably, the guide plate further includes a standard marking corresponding to a cutting line or an index line.

More preferably, the guide plate has a semicircular shape, and the guide slot also has a semicircular shape.

### BRIEF DESCRIPTION OF THE DRAWINGS

Other objects and aspects of the present invention will become apparent from the following description of embodiments with reference to the accompanying drawing in which:

FIG. 1 is a perspective view showing a guide device for cutting work according to a preferred embodiment of the present invention;

FIG. 2 is a perspective view showing a bottom of a sliding support applied to the guide device for cutting work according to one embodiment of the present invention;

FIG. 3 is a sectional view taken along III-III′ line of FIG. 1;

FIG. 4 is a perspective view showing that the guide device for cutting work according to one embodiment of the present invention is in use;

FIG. 5 is a perspective view showing a guide device for cutting work according to another embodiment of the present invention; and

FIG. 6 is a perspective view showing a bottom of a sliding support applied to the guide device of FIG. 5.

### DESCRIPTION OF THE PREFERRED EMBODIMENT

Hereinafter, the present invention will be described in more detail referring to the drawings.

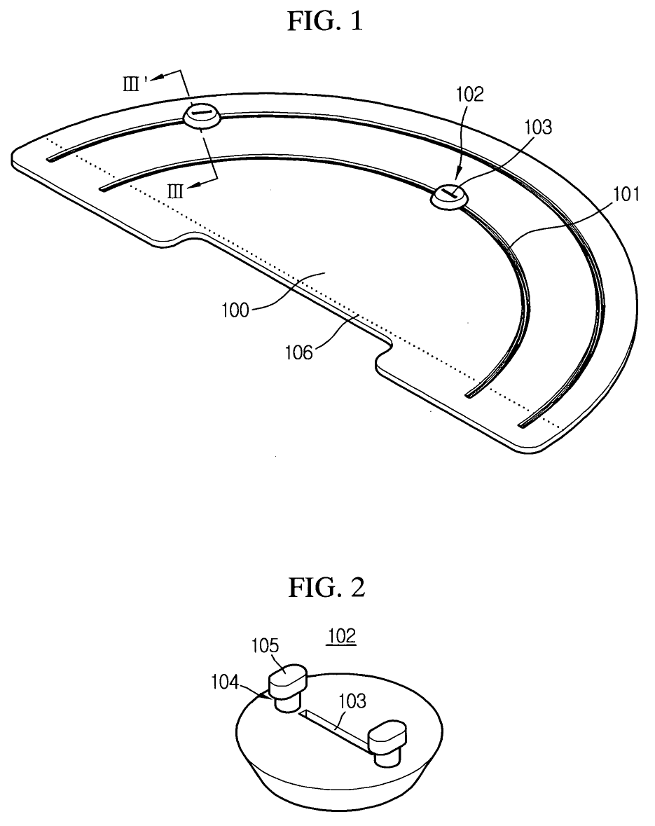

FIG. 1 is a perspective view showing a guide device for cutting work according to a preferred embodiment of the present invention.

Referring to FIG. 1, the guide device of this embodiment includes a guide plate 100 having a guide slot 101, and a sliding support 102 combined in the guide slot 101 to be sliding along the guide slot 101.

The guide plate 100 has a plate structure so as to be placed on a sheet material such as various films, cloths, cards and papers. Preferably, the guide plate 100 is made of transparent material so that the sheet material positioned under it may be seen through it.

The guide plate 100 may have various shapes according to the shape of a cutting line that a user desires to cut along. In FIG. 1, the guide plate 100 has a semicircular shape as an example, which is suitable for cutting the sheet material into a circular shape.

The guide slot 101 is formed in the guide plate 100 in correspondence to the cutting line of the sheet material. In this embodiment, the guide slot 101 has a semicircular shape so as to cut the sheet material into a circular shape. Preferably, the guide plate 100 may have a plurality of guide slots 101 with different radii.

The sliding support 102 is combined to the guide slot 101 to be sliding so that a cutting blade for cutting the sheet material may be inserted and supported therein. A detailed configuration of the sliding support 102 is seen in the perspective view of FIG. 2, which shows its bottom.

The sliding support 102 has a slit 103 for inserting a cutting blade in the same direction as the guide slot 101. The cutting blade for cutting a sheet material is inserted and supported in the slit 103 of the sliding support 102.

In addition, a pair of combination members 104 combined to the guide slot 101 of the guide plate 100 are formed on the bottom surface of the sliding support 102. Preferably, the combination members 104 have a rod shape having a hooking portion 105 at its end. The hooking portion 105 has a size greater than a gap of the guide slot 101. The combination members 104 should be formed on an extension line of the slit 103 since it moves along the guide slot 101. In this embodiment, the combination members 104 are formed to be opposite to each other with the slit 103 being interposed between them.

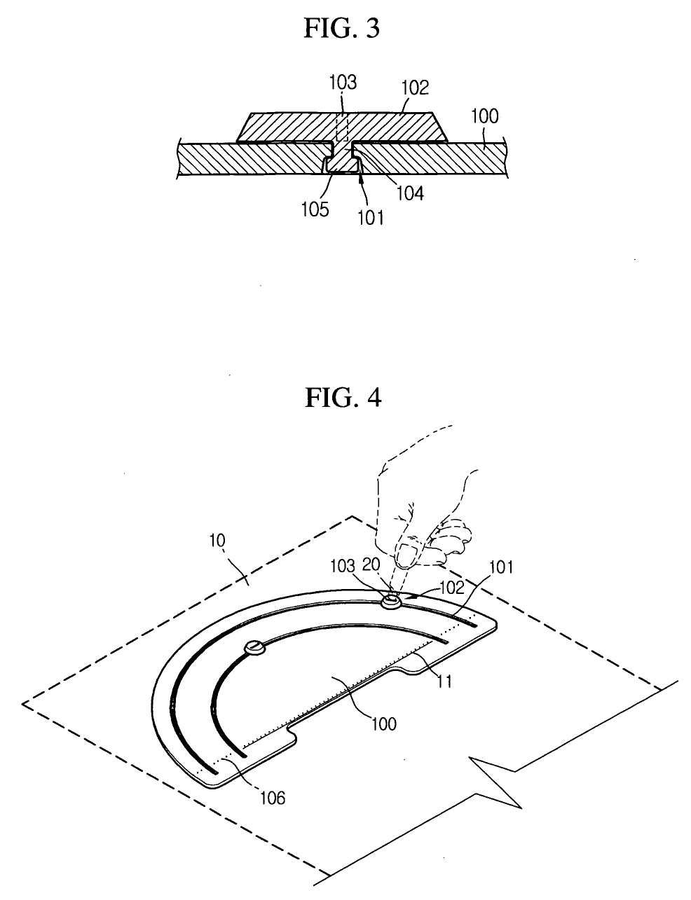

The sliding support 102 is fit into the guide slot 101 of the guide plate 100 so as to slide therein, as shown in FIG. 3. That is to say, if the combination members 104 of the sliding support 102 are pushed into the guide slot 101, the hooking portions 105 of the combination members 104 are forcibly passed through the guide slot 101, then preventing the sliding support 102 from deviating from the guide plate 100.

With the sliding support 102 being combined to the guide plate 100, the slit 103 for inserting a cutting blade is formed in the same direction as that of the guide slot 101.

Additionally, the guide plate 100 may have a standard marking 106 that is formed in correspondence to a cutting line or a separate index line of the sheet material so as to facilitate each cutting of the sheet material. In the embodiment of FIG. 1, the standard marking 106 is a straight line passing through the center of the semicircle.

The guide device for cutting work according to this embodiment, configured as mentioned above, is used in the following way.

In this embodiment, a sheet material such as a paper 10 will be cut into a circular shape.

Referring to FIG. 4, an index line 11 is marked on the paper 10, and then the guide device of the present invention is placed on a paper 10 so that the index line 11 is coincided with the standard marking 106.

Subsequently, a user inserts a cutting blade 20 into the slit 103 of the sliding support 102 so that the cutting blade 20 comes in contact with the paper 10. In this state, if the cutting blade 20 is moved, the sliding support 102 is also moved along the guide slot 101. Accordingly, the cutting blade 20 supported by the sliding support 102 cuts the paper 10 in accordance with the pattern of the guide slot 101, e.g. into a semicircular shape.

After that, the guide plate 100 is turned 1800 so as to be placed in an opposite direction, and then arranged so that the standard marking 106 is coincided with the index line 11 of the paper 10.

In this state, the cutting blade 20 is inserted into the slit 103 of the sliding support 102 in the same way as mentioned above, and then moved to cut a remained semicircle. As a result, the paper 10 is cut into a circular shape. In this case, the standard marking 106 between two semicircles should match identically, of course.

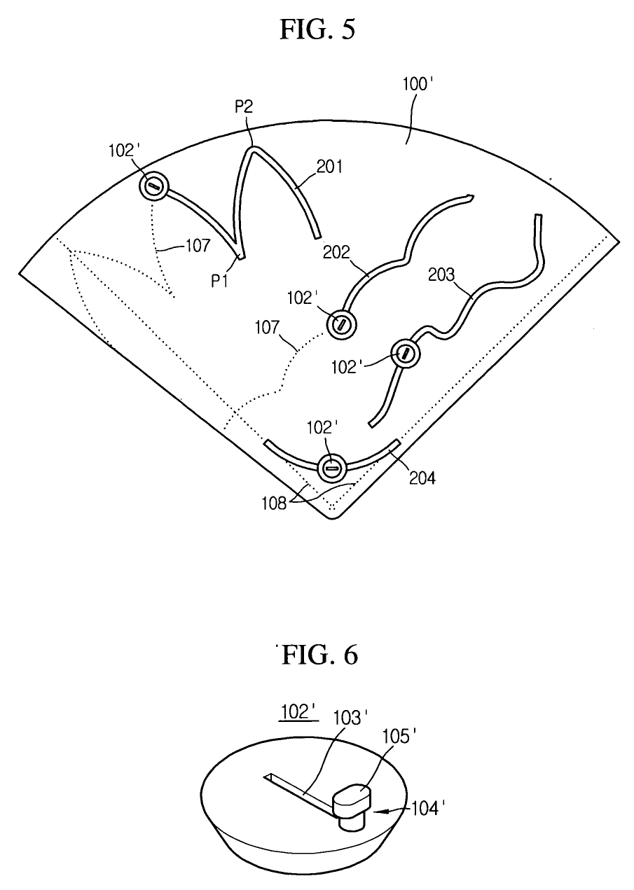

FIG. 5 shows a guide device for cutting work according to another embodiment of the present invention. Referring to FIG. 5, the guide device of this embodiment enables it to cut a sheet material into various complex shapes, for example a petaline shape, in addition to a circular shape.

The guide device of this embodiment also includes a guide plate 100′ placed on a sheet material and a sliding support 102′ combined to slide in the guide plate 100′ like the former embodiment.

The guide plate 100′ has guide slots 201, 202, 203 and 204 with various cutting patterns. For example, the guide slot 201 is used for cutting a sheet material into a petaline shape, the guide slot 202 is used for cutting a sheet material into a wave shape, the guide slot 203 is used for cutting a sheet material into an irregular wave form, and the guide slot 204 is used for cutting a corner of a sheet material to be rounded.

In this embodiment, the guide slot 201 has at least one critical point P1 and P2 where a cutting line is sharply curved. This critical point mathematically includes an extreme point or a non-differentiable point. Thus, an advancing direction of a cutting blade for cutting a sheet material should be sharply changed at the critical points P1 and P2, and the sliding support 102′ that supports the cutting blade should also be sharply rotated accordingly. For this purpose, the sliding support 102′ of this embodiment has only single combination member 104′ as shown in FIG. 6. The combination member 104′ should be also formed on an extension line of a slit 103′ for insertion of the cutting blade, which is formed on the sliding support 102′, as in the former embodiment.

The combination member 104′ is forcibly pushed into the guide slot 201 of the guide plate 100′ so that a hooking portion 105′ thereof is passed through and supported by the guide slot 201.

In addition, standard markings 107 and 108 may be formed on the guide plate 100′ so as to be successively connected to at least one pattern of the guide slots 201, 202, 203 and 204. For example, the standard marking 107 is marked to be extended with the same pattern as the guide slots 201 and 202. This standard marking 107 is used for repeating forming of the same cutting pattern. Meanwhile, the standard marking 108 has two straight lines orthogonal to each other, which are coincided with edges of the sheet material. This standard marking 108 is used for arranging the guide slot 204 at the edges of the sheet material.

The process of cutting a paper 10 using the guide device of this embodiment, where a cutting blade 20 (see FIG. 4) is inserted into the slit 103′ of the sliding support 102′ located at an initial position of the guide slot 201 to cut the paper 10, is identical to the process of the former embodiment.

After the paper 10 is cut by moving the cutting blade 20 and the sliding support 102′ to the critical point P1 of the guide slot 201, an advancing direction of the cutting blade 20 is changed toward the critical point P2 at the critical point P1. Accordingly, the sliding support 102′ that supports the cutting blade 20 should also change its direction. At this time, since the sliding support 102′ is combined to the guide slot 201 by means of the single combination member 104′ as mentioned above, the sliding support 102′ may freely rotate on the basis of the combination member 104′. Thus, the sliding support 102′ is freely rotated at the critical point P1, thereby allowing the cutting work up to the critical point P2. Changing an advancing direction at the next critical point P2 is conducted in the same way as in the critical point P1.

By using this procedure, the sheet material may be cut into various patterns such as a petaline shape and a wave shape.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

According to the present invention, the cutting blade for cutting a sheet material is supported and moved in the sliding support, thereby making the cutting work stable and accurate.

In addition, since the sliding support may freely rotate at a critical point, it is possible to stably form various cutting patterns.

What is claimed is:

1. A guide device for cutting work, which is placed on a sheet material to guide a cutting blade that cuts the sheet material, the guide device comprising:
a guide plate having a guide slot corresponding to a cutting line; and
a sliding support combined in the guide slot to be sliding along the guide slot,
wherein a slit for inserting the cutting blade is formed in the sliding support in the same direction as the guide slot so that the cutting blade is inserted and supported in the slit.

2. The guide device for cutting work according to claim 1,
wherein the sliding support includes a combination member inserted into the guide slot, the combination member having a hooking portion with a greater size than a gap of the guide slot, and
wherein the combination member is formed on an extension line of the slit for inserting the cutting blade.

3. The guide device for cutting work according to claim 2,
wherein the combination member is composed of a pair of members opposite to each other with the slit being interposed therebetween.

4. The guide device for cutting work according to claim 2,
wherein the guide slot has at least one critical point, and
wherein the sliding support includes only single combination member.

5. The guide device for cutting work according to claim 4,
wherein the guide plate further includes a standard marking corresponding to a cutting line or an index line.

6. The guide device for cutting work according to claim 2,
wherein the guide plate has a semicircular shape, and the guide slot also has a semicircular shape.
